(19) United States
(12) Patent Application Publication
(10) Pub. No.: US 2008/0193816 A1
(43) Pub. Date: Aug. 14, 2008

(54) Fuel cell with substrate-patterned lower electrode

(76) Inventors: Samuel B. Schaevitz, Fremont, CA (US); Roger W. Barton, Grand Marais, MN (US); Zachary Byars, Cambridge, MA (US); Aleksander Franz, Winchester, MA (US)

Correspondence Address: ROPES & GRAY LLP, PATENT DOCKETING 39/41, ONE INTERNATIONAL PLACE, BOSTON, MA, 02110-2624, US

(21) Appl. No.: 11/890,823

(22) Filed: Aug. 7, 2007

Related U.S. Application Data
(63) Continuation-in-part of application No. 11/416,219, filed on May 2, 2006.

(51) Int. Cl. H01M 8/00; H01M 4/00

(52) U.S. Cl. 429/27; 427/115

(57) ABSTRACT

Electrically separate fuel cell units that may be connected in series or in parallel. More particularly, in one aspect, the solid oxide fuel cells include a substrate having multiple apertures, multiple electrically separate lower electrodes, such that at least one of the lower electrodes covers at least a portion an aperture, an electrolyte layer positioned on the lower electrodes, and an upper electrode layer positioned on the electrolyte layer. The electrolyte layer may be positioned on a portion of the upper surface of the substrate. One or more of the lower electrodes may cover at least a portion of a sidewall of one or more of the apertures.

### REFERENCE TO RELATED APPLICATIONS

The present applications claims priority to and is a continuation-in-part of U.S. patent application Ser. No.: 11/416,219, entitled: SYSTEMS AND METHODS FOR STACKING FUEL CELLS, filed May 2, 2006 and naming Samuel B. Schaevitz, Roger Barton, Zachary Byars and Aleksander Franz as inventor, and the contents of which are incorporated by reference herein.

### BACKGROUND

Fuel cells produce electricity from chemical reactions. The chemical reactions typically react a fuel, such as hydrogen, and air/oxygen as reactants, and produce water vapor as a primary by-product. The hydrogen can be provided directly, in the form of hydrogen gas, or can be produced from other materials, such as hydrocarbon liquids or gasses, which are reformed to isolate hydrogen gas. Fuel cell assemblies may include one or more fuel cells in a fuel cell housing that is coupled with a fuel canister containing the hydrogen and/or hydrocarbons. Fuel cell housings that are portable coupled with fuel canisters that are portable, replaceable, and/or refillable, compete with batteries as a preferred electricity source to power a wide array of portable consumer electronics products, such as cell phones and personal digital assistants. The competitiveness of these fuel cell assemblies when compared to batteries depends on a number of factors, including their size, efficiency, power output, and reliability.

However, these factors are constrained by limitations in the art. For example, fuel cells are often formed on a substrate, such that each fuel cell unit on a given substrate is electrically connected, in parallel, with other fuel cell units on the substrate. This limits the magnitude of the voltage which can be produced by a fuel cell.

Thus, a need exists for fuel cell assemblies and fabrication methods that provide fuel cells which overcome limitations in the art.

### SUMMARY

The invention, in various embodiments, addresses deficiencies in the prior art by providing electrically separate fuel cell units. In certain embodiments, the fuel cell units may be connected in series or in parallel. More particularly, in one aspect, the invention provides a solid oxide fuel cell including a substrate having multiple apertures, multiple physically separate lower electrodes, such that at least one of the lower electrodes covers at least a portion an aperture, an electrolyte layer positioned on the lower electrodes, and an upper electrode layer positioned on the electrolyte layer. The electrolyte layer may be positioned on a portion of the upper surface of the substrate. One or more of the lower electrodes may cover at least a portion of a sidewall of one or more of the apertures. In one embodiment, each of the apertures is a separate electrical unit.

According to one embodiment, the lower electrodes are not disposed on either the lower surface of the substrate or the upper surface of the substrate. In this embodiment, the lower electrodes are positioned within the apertures, and may contact the sides of the substrate within the apertures, but do not contact the upper or lower surfaces of the substrate.

According to one embodiment, the solid oxide fuel cell includes one or more electrical vias within the electrolyte layer. The one ore more electrical vias may be located in an area of the electrolyte layer covering an aperture. The one or more electrical vias may electrically connect one or more of the lower electrodes with the upper electrode layer. In another embodiment, the fuel cell includes a wire electrically connecting at least two of the lower electrodes. The wire is constructed of a conductive material, and may be made of platinum.

According to one embodiment, the upper electrode layer is patterned. The upper electrode layer may be patterned to include apertures. The upper electrode may be patterned to form multiple individual upper electrodes. In one embodiment, the fuel cell includes an insulating and stress absorbing layer.

According to one aspect, the invention provides a method for producing a solid oxide fuel cell including providing a substrate having a multiple apertures, providing an electrolyte layer covering at least a portion of the apertures, forming an upper electrode layer on an upper surface of the electrolyte layer, and forming multiple lower electrodes on a lower surface of the electrolyte layer within the apertures, such that the lower electrodes are physically separate. In one embodiment, one or more of the lower electrodes covers a portion of a sidewall of one or more of the apertures. In one embodiment, each of the apertures is a separate electrical unit.

According to one embodiment, the method includes disposing one or more electrical vias within the electrolyte layer. The one or more electrical vias may be located in an area of the electrolyte layer covering at least one of the plurality of apertures, and electrically connects one or more of the lower electrodes with the upper electrode layer. According to another embodiment, the method includes providing a wire, which electrically connects two or more of the lower electrodes. The wire may be made of platinum.

According to another embodiment, the method includes patterning the upper electrode layer. The upper electrode may be patterned using micromachining techniques. In some implementations, the upper electrode layer is patterned using photolithography or stamping. According to some embodiments, the substrate is also patterned, and may be patterned using micromachining techniques. In one embodiment, the method includes forming insulating and stress absorbing layer on a surface of the substrate.

### BRIEF DESCRIPTION OF THE DRAWINGS

These and other features and advantages will be more fully understood by the following illustrative description with reference to the appended drawings, in which like elements are labeled with like reference designations and which may not be drawn to scale.

FIG. 1A shows a cross-sectional view of a fuel cell stack according to an illustrative embodiment of the invention.

FIG. 1B shows a bottom angle view of the fuel cell stack of FIG. 1A.

FIGS. 2A-2E depict embodiments of the fuel cell stack during manufacturing according to an illustrative embodiment of the invention.

FIGS. 3A-3D depict various fuel cell stack embodiments, according to various illustrative embodiments of the invention.

### DETAILED DESCRIPTION OF THE ILLUSTRATIVE EMBODIMENTS

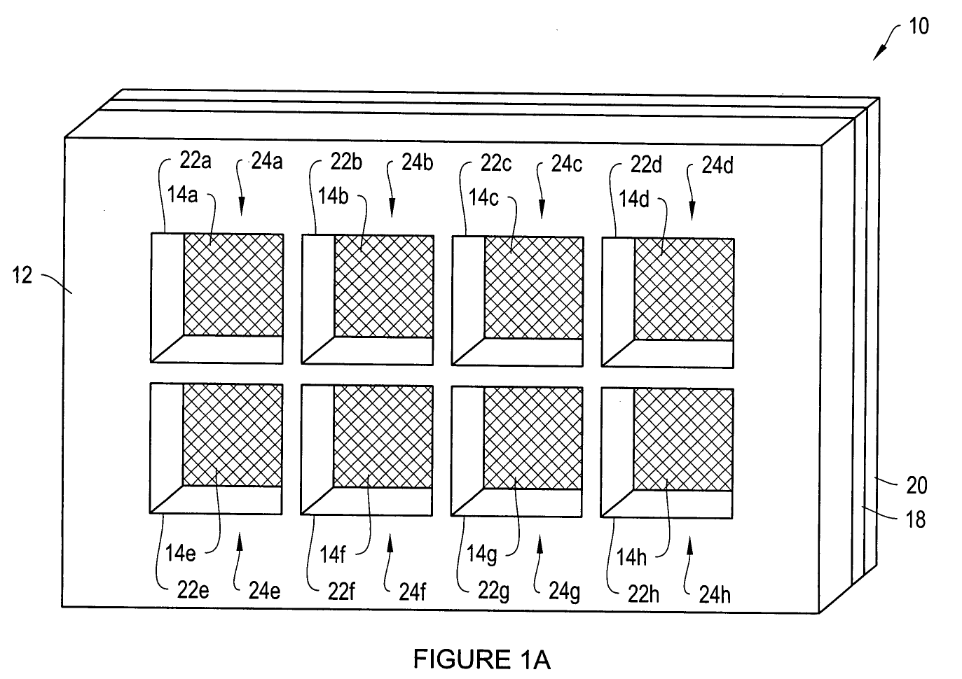

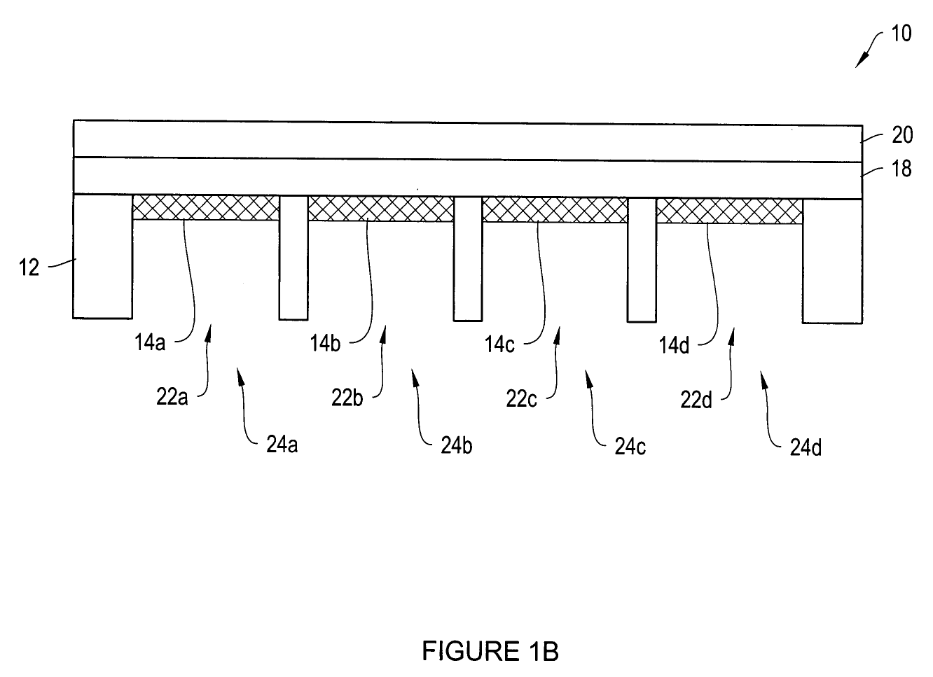

The systems and methods described herein, in various embodiments, provide, among other things, devices and methods for portable fuel cell assemblies. FIGS. 1A and 1B depict a bottom angled view and a cross-sectional view, respectively, of a fuel cell stack 10, including a substrate 12, lower electrodes 14a-14h, electrolyte 18, and upper electrode 20. The substrate 12 has multiple apertures 22a-22h, and the lower electrodes 14a-14h are disposed within the apertures 22a-22h respectively. The electrolyte 18 is positioned on an upper surface of the substrate 12, covering the apertures 22a-22h, such that the electrolyte 18 contacts the lower electrodes 14a-14h. The upper electrode 20 is positioned on the upper surface of the electrolyte 18. In some embodiments, the electrolyte 18 includes electrical vias which provide electrical connections between the upper electrode 20 and respective lower electrodes 14a-14h.

According to one feature of the illustrative embodiment, since the lower electrodes 14a-14h are unattached, the fuel stack 10 includes separate fuel cell units 24a-24h located within each aperture 22a-22h. The fuel cell units 24a-24h produce electricity when a fuel contacts one side of the fuel stack 10, and oxygen contacts the opposite side of the fuel stack 10. For example, the fuel cell stack 10 may be positioned as part of a fuel cell assembly such that a fuel contacts the lower electrodes 14a-14h and oxygen contacts the upper electrode 20. Exemplary fuel types include hydrogen, carbon monoxide, hydrocarbon based fuels such as methane, ethane, methanol, butane, pentane, methanol, formic acid, ethanol, and/or propane, and/or non-hydrocarbon based fuels such as ammonia or hydrazine. The hydrogen and oxygen electrochemically react with the lower electrodes 14a-14h, the electrolyte 18, and the upper electrode 20 to produce voltage differentials between the lower electrodes 14a-14h and the upper electrode 20. The respective voltage differentials created by the fuel cell units 24a-24h may be combined either in series or in parallel using an electrical connection (not shown), and may be used to drive electrical current and power a load.

The lower electrodes 14a-14h, and the upper electrode 20 may be composed of a wide variety of materials, including, for example, cermet composites such as nickel and YSZ cermets, platinum, silver, palladium, iron, cobalt, ceria, other oxide matrix materials, lanthanum (strontium) manganate (LSM), lanthanaum (strontium) cobaltite (LSC), lanthanum (strontium) cobalt-ferrite (LSCF), and combinations of these materials. The electrolyte layer 18 may be composed of yttria-stabilized zirconia (YSZ) and/or doped ceria materials. Other materials, configurations, and fabrication methods for the electrolyte layer 18 are described in PCT application WO 2005/030376, incorporated herein by reference in its entirety.

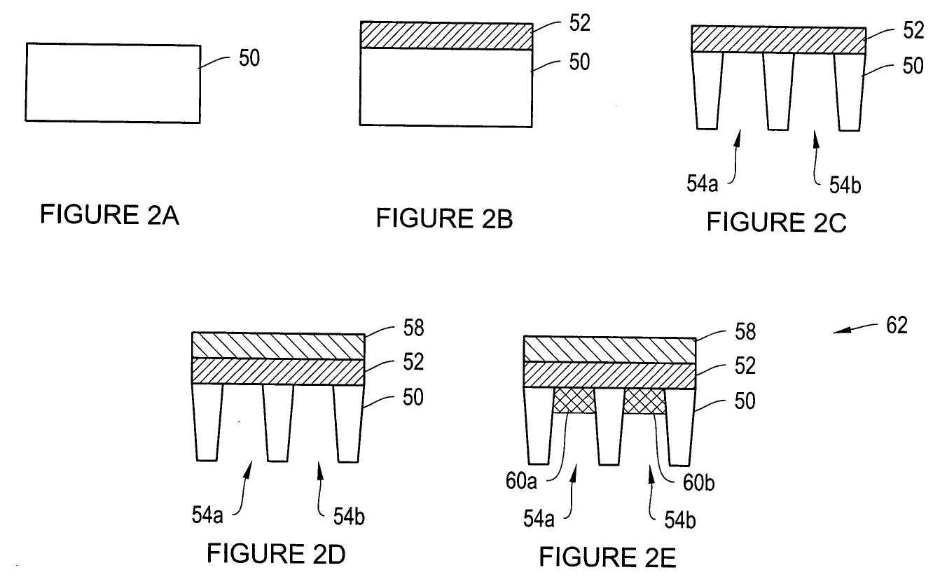

FIGS. 2A-2E depict a method of manufacturing a fuel cell stack, including certain embodiments of the fuel cell stack during the manufacturing method. FIG. 2A depicts a substrate 50. The substrate 50 may be composed of silicon. As shown in FIG. 2B, an electrolyte 52 is disposed on an upper surface of the substrate 50. Next, in FIG. 2C, one or more apertures 54a-54b are created in the substrate 50. The apertures 54a-54b may be created by an etching method, a sputtering method, an evaporation method, or any other selected method. As shown in FIG. 2D, an upper electrode 58 is disposed on the upper surface of the electrolyte 52. In alternative embodiments, the upper electrode 58 is disposed on the upper surface of the electrolyte 52 before forming the apertures 54a and 54b in the substrate 50. In FIG. 2E, lower electrodes 60a and 60b are formed on the lower surface of the electrolyte 52 within the apertures 54a and 54b, forming a fuel cell stack 62.

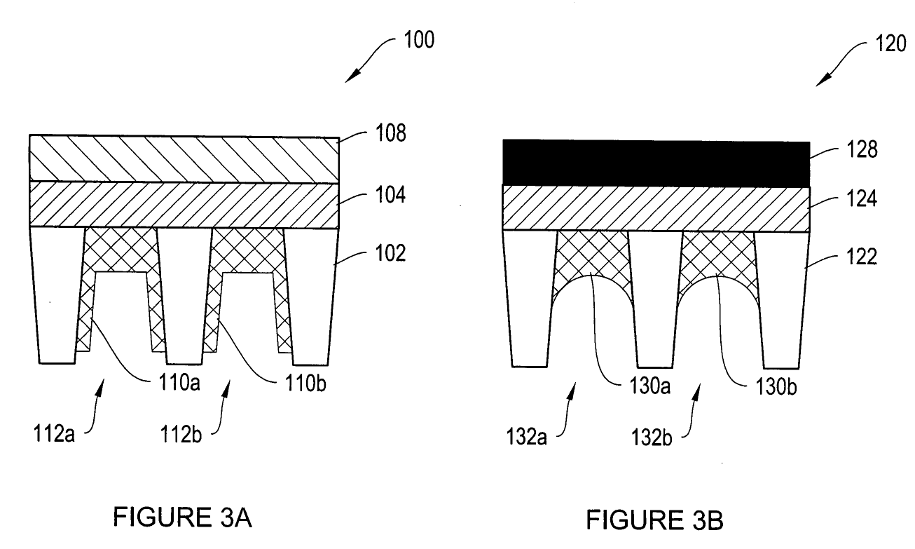

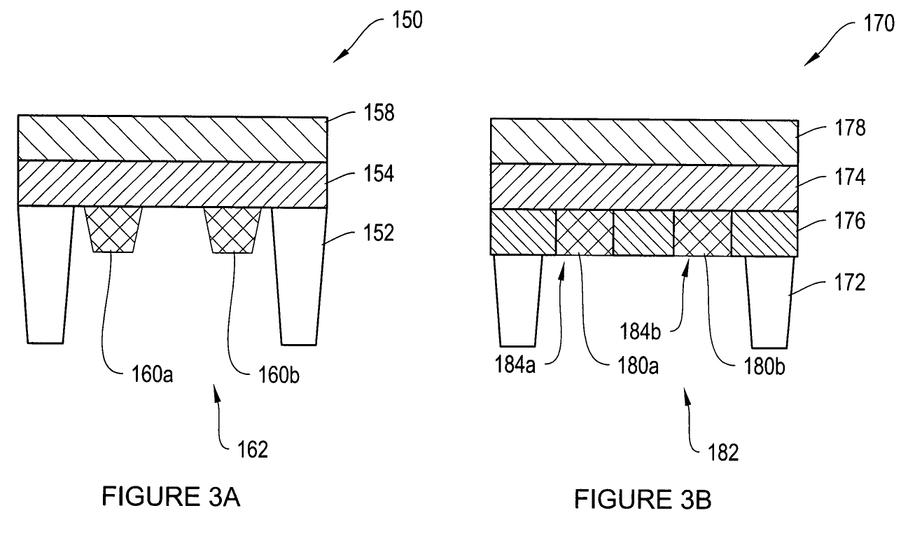

FIGS. 3A-3D depict various fuel cell stack embodiments. FIG. 3A shows a fuel cell stack 100, including a substrate 102, an electrolyte 104, an upper electrode 108, and lower electrodes 110a and 110b. The substrate 102 includes apertures 112a and 112b. The lower electrodes 110a and 110b are positioned on the lower surface of the electrolyte 104, and along the sidewalls of the apertures 112a and 112b. The lower electrodes 110a and 110b may extend any selected distance along the sidewalls of the apertures 112a and 122b.

FIG. 3B shows a fuel cell stack 120, including a substrate 122, an electrolyte 124, an upper electrode 128, and lower electrodes 130a and 130b. The substrate 122 includes apertures 132a and 132b. As shown in the illustrative embodiment, the lower electrodes 130a and 130b, positioned on the lower surface of the electrolyte 124 within the apertures 132a and 132b, may have a non-uniform thickness, and may extend any selected distance along the sidewalls of the apertures 132a and 132b.

FIG. 3C shows a fuel cell stack 150, including a substrate 152, an electrolyte 154, an upper electrode 158, and lower electrodes 160a and 160b. The substrate 152 includes an aperture 162. As shown in the illustrative embodiment, the lower electrodes 160a and 160b are both positioned within the aperture 162. The lower electrodes 160a and 160b are physically and electrically separate units.

FIG. 3D shows a fuel cell stack 170, including a substrate 172, an electrolyte 174, an upper electrode 178, lower electrodes 180a and 180b, and an insulating layer 176. The insulating layer 176 is positioned between the substrate 172 and the electrolyte 174, and includes apertures 184a and 184b. The substrate 172 also includes an aperture 182. As shown in the illustrative embodiment, the lower electrodes 180a and 180b are positioned within the apertures insulating layer 176 apertures 184a and 184b, which are within the aperture 182. The lower electrodes 180a and 180b are physically and electrically separate units.

Fuel cell stacks of the type depicted in FIG. 3D may be used in a device, such as the fuel cell devices shown and described in the above referenced U.S. patent application, U.S. Ser. No.: 11/416,219, entitled: SYSTEMS AND METHODS FOR STACKING FUEL CELLS, the contents of which have been incorporated by reference. Thus, the stacks described herein may be employed as part of fuel cell units that have planar stacks within a fuel cell housing, to provide increased voltages, currents, and/or power.

In fuel cell stacks in which the fuel cell unit lower electrodes are constructed from a single layer of material, and remain attached as a single lower electrode, the fuel cell units are all connected in parallel. Thus, the voltage provided by a set of connected fuel cell units is predetermined and cannot be varied. Additionally, if one fuel cell unit of the set of connected fuel cells units is shorted, then the set of connected fuel cell units is shorted. The physically separate lower electrodes described herein may be connected with external wires in any selected manner, including in series, in parallel, or in a combination thereof. In one embodiment, one or more of the electrically separate lower electrodes are not connected with an external wire, and instead are connected to the upper electrode by an electrical via through the electrolyte layer. Throughout this application, the phrase “electrically separate electrodes” is taken to mean, although not be limited to, electrodes which are not physically connected to form a monolithic or contiguous electrode. However, the “electrically separated” phrase is not intended to limit the scope of the invention against cases where the electrodes are physically separated, but electrically connected together electrically with wires, leads, other electrical components, or any other configuration which optionally combines the separate electrodes into a common electrical circuit.

While this invention has been particularly shown and described with references to preferred embodiments thereof, it will be understood by those skilled in the art that various changes in form and details may be made therein without departing from the scope of the invention encompassed by the appended claims.

What we claim is:

1. A solid oxide fuel cell, comprising
a substrate having a plurality of apertures;
a plurality of lower electrodes, wherein at least one of the plurality of lower electrodes covers at least a portion of at least one of the plurality of apertures, and wherein the respective ones of the plurality of lower electrodes are physically separate;
an electrolyte layer positioned on the plurality of lower electrodes; and
an upper electrode layer positioned on the electrolyte layer.

2. The fuel cell of claim 1, wherein at least one of the plurality of lower electrodes covers a portion of a sidewall of at least one of the plurality of apertures.

3. The fuel cell of claim 1, further comprising at least one electrical via within the electrolyte layer.

4. The fuel cell of claim 3, wherein the at least one electrical via is located in an area of the electrolyte layer covering at least one of the plurality of apertures.

5. The fuel cell of claim 3, wherein the at least one electrical via electrically connects at least one of the plurality of lower electrodes with the upper electrode layer.

6. The fuel cell of claim 1, wherein the upper electrode layer is patterned.

7. The fuel cell of claim 1, wherein each of the plurality of apertures comprises a separate electrical unit.

8. The fuel cell of claim 1, further comprising an insulating and stress absorbing layer.

9. The fuel cell of claim 1, further comprising a wire, wherein the wire electrically connects at least two of the plurality of lower electrodes.

10. The fuel cell of claim 1, wherein the plurality of lower electrodes are not disposed on a lower surface of the substrate and the plurality of lower electrodes are not disposed on an upper surface of the substrate.

11. The fuel cell of claim 1, wherein the electrolyte layer is positioned on at least a portion of an upper surface of the substrate

12. A method for producing a solid oxide fuel cell comprising:
providing a substrate having a plurality of apertures;
providing an electrolyte layer covering at least a portion the plurality of apertures;
forming an upper electrode layer on an upper surface of the electrolyte layer;
forming a plurality of lower electrodes on a lower surface of the electrolyte layer within respective ones of the plurality of apertures, such that respective ones of the plurality of lower electrodes are physically separate.

13. The method of claim 12, wherein at least one of the plurality of lower electrodes covers a portion of a sidewall of at least one of the plurality of apertures.

14. The method of claim 12, further comprising disposing at least one electrical via within the electrolyte layer.

15. The method of claim 14, wherein the at least one electrical via is located in an area of the electrolyte layer covering at least one of the plurality of apertures.

16. The method of claim 14, wherein the at least one electrical via electrically connects at least one of the plurality of lower electrodes with the upper electrode layer.

17. The method of claim 12, further comprising patterning the upper electrode layer.

18. The method of claim 12, wherein each of the plurality of apertures comprises a separate electrical unit.

19. The method of claim 12, further comprising forming insulating and stress absorbing layer on a surface of the substrate.

20. The method of claim 12, further comprising providing a wire, wherein the wire electrically connects at least two of the plurality of lower electrodes.

21. The method of claim 12, wherein the plurality of lower electrodes are not disposed on a lower surface of the substrate and the plurality of lower electrodes are not disposed on an upper surface of the substrate.

22. The method of claim 12, wherein the electrolyte layer is formed on at least a portion of an upper surface of the substrate

23. The method of claim 12, wherein at least two of the plurality of lower electrodes are formed within one of the plurality of apertures.
